(19) United States
(12) Patent Application Publication
(10) Pub. No.: US 2025/0250171 A1
(43) Pub. Date: Aug. 7, 2025

(54) Hard carbon material for storing alkali metal ions and its producing method

(71) Applicant: LONG TIME TECH. CO., LTD., New Taipei (TW)

(72) Inventors: Wen-Chun Yen, New Taipei (TW); Lie-Kai Liu, New Taipei (TW); Liang-William Hwang, New Taipei (TW); Yong-Cheng Zou, New Taipei (TW)

(21) Appl. No.: 18/749,692

(22) Filed: Jun. 21, 2024

(30) Foreign Application Priority Data
Feb. 7, 2024 (TW) 113105239

(51) Int. Cl. C01B 32/05

(52) U.S. Cl. CPC C01B 32/05; C01P 2002/72; C01P 2002/82; C01P 2004/64; C01P 2006/40; C01P 2006/80

(57) ABSTRACT

A hard carbon material for storing alkali metal ion and its producing method are disclosed. Specifically, the hard carbon material has a hydrogen content less than 2 wt. %, an ordered length between 0 and 20 nm, a layer spacing more than 0.36 nm and intensity ratio of the D band to G band in Raman spectrum is between 1.0 and 1.3. The producing method is operated below 1800° C., so it is an energy saving process.

### TECHNICAL FIELD

The invention relates to a hard carbon material for storing alkali metal ions and its producing method thereof. The hydrogen content of the hard carbon material for storing alkali metal ions is less than 2 wt. % and its layer spacing is greater than 0.36 nm. Specifically, the present invention achieves the purpose of controlling the hydrogen content and layer spacing by adjusting the process temperature and doping additives.

### BACKGROUND

With the rapid development of electronic products, electric vehicles and green energy-related industries, the market demand for ion batteries with high metal ion storage capacity and high efficiency has also increased. The traditional negative electrode materials currently used in ion batteries on the market are mainly graphite and its derivatives. However, the low theoretical gram capacity and low discharge efficiency of conventional negative electrode materials have always been technical bottlenecks that are difficult to break through for battery negative electrode materials. In metal ion batteries, their layer spacing is too small and they cannot form a stable intercalation structure, which has led to subsequent applications and subject to considerable restrictions.

In view of the above, developing a new type of composite negative electrode material with high metal ion storage capacity and long cycle life is an urgent technical target for breakthrough and development of today's ion batteries.

### SUMMARY OF THE INVENTION

In view of the above background of the invention and to meet the requirements of the industry, the invention discloses a novel hard carbon material for storing alkali metal ions and a production method thereof. Specifically, the hydrogen content of the hard carbon material for storing alkali metal ions of the present invention is less than 2 wt. %, and its order length (La) ranges from 0 to 20 nm and its layer spacing is greater than 0.36 nm. Moreover, the hard carbon material that stores alkali metal ions of the present invention has higher alkali metal ions storage capacity and coulombic efficiency, and can greatly improve the shortcomings of traditional hard carbon materials. The production method provided by the invention adopts a low-temperature sintering process to fabricate the hard carbon material for storing alkali metal ions, and at the same time, through temperature adjustment and doping additives, the hard carbon material for storing alkali metal ions has hydrogen content less than 2 wt. %, order length (La) range of 0-20 nm, and the layer spacing of greater than 0.36 nm.

In one aspect, the hard carbon material for storing alkali metal ions uses phenolic resin, petroleum coke, coal, biomass or a mixture thereof as a precursor, and then undergoes manufacturing processes and doping procedures at different temperatures to produce the hard carbon material for storing alkali metal ions.

Specifically, the hard carbon material for storing alkali metal ions has hydrogen content less than 2 wt. %, order length (La) range of 0-20 nm, and the layer spacing of greater than 0.36 nm. Due to the above material characteristics, the hard carbon material for storing alkali metal ions of the present invention is a hard carbon material with high alkali metal ions storage capacity.

In another aspect, the invention provides a method for producing a hard carbon material for storing alkali metal ions. Specifically, the method comprises but is not limited to the steps of pre-carbonization, crushing, doping and carbonization. More specifically, the invented method adopts two stages of process technology with different temperatures, and controls the hydrogen content to be less than 2 wt. % through temperature adjustment. Furthermore, the process temperature of the invented method is controlled within 1800° C. to avoid a significant narrowing of the layer spacing of the hard carbon material due to high temperatures. At the same time, the process of narrowing the layer spacing is further hindered by doping different additives, thereby the ordered length (La) range of the hard carbon material for storing alkali metal ions of the present invention is controlled to be 0-20 nm and its layer spacing is greater than 0.36 nm.

According to the above-mentioned purpose of the invention, to overcome the shortcomings of low metal ion storage capacity of conventional negative electrode materials, the present invention discloses a novel hard carbon material for storing alkali metal ions. Specifically, the hydrogen content of the hard carbon material for storing alkali metal ions is less than 2 wt. % and its order length (La) range is 0-20 nm and its layer spacing is greater than 0.36 nm. Furthermore, the hard carbon material for storing alkali metal ions of the present invention uses low-temperature processes and doping additives to control the upper limit of the hydrogen content of the hard carbon material and prevent the layer spacing from narrowing, thereby improving the material quality and efficacy of alkali metal ions storage capacity. Accordingly, the hard carbon material for storing alkali metal ions of the present invention has higher alkali metal ions storage capacity and can be widely used as negative electrodes material for lithium-ion batteries, sodium-ion batteries or potassium-ion batteries. Secondly, the present invention provides a method for producing hard carbon materials that store alkali metal ions. Specifically, the production method uses steps such as low-temperature pre-carbonization, crushing, doping and carbonization to produce a hydrogen content of less than 2 wt. %, and the hard carbon material with a high ability for storing alkali metal ions has order length (La) ranging from 0 to 20 nm and layer spacing being greater than 0.36 nm. The production method of the present invention uses a low-temperature sintering process, and the operating temperature in the entire process is less than 1800° C. By this technical means, the technical effect of controlling the upper limit of hydrogen content and the lower limit of layer spacing is achieved, and at the same time, additives are added before carbonization to prevent the layer spacing is significantly narrowed at the operating temperature of carbonization, thereby creating a synergistic effect. Accordingly, the production method of the present invention prepares the hard carbon materials with high alkali metal ions storage capacity by technical means of temperature control and doping additives. Compared with the conventional process of preparing hard carbon materials at high temperatures exceeding 2000° C., since the operating temperatures of the process of the present invention are lower than 1800° C., the production method of the present invention also has the technical advantages of environmental protection and energy saving, and can be used more widely in industries related to hard carbon materials and anode materials.

### BRIEF DESCRIPTION OF THE DRAWINGS

FIG. 1 is a schematic diagram of the parameters and structure of graphite crystal;

FIG. 2 is X-ray diffraction patterns of the hard carbon materials made at different temperatures of the present invention;

FIG. 3 is Raman spectra of the hard carbon materials made at different temperatures of the present invention;

FIG. 4 is a graph showing the relationship between cycle number and specific capacity of batteries using the hard carbon materials made at different temperatures of the present invention as negative electrode materials;

FIG. 5 is an impedance diagram of a battery using the hard carbon materials made at different temperatures of the present invention as negative electrode materials;

FIG. 6 is a graph showing the relationship between voltage and specific capacity of a battery using the hard carbon material made at 1500° C. of the present invention as the negative electrode material;

FIG. 7 is a graph showing the relationship between cycle number and specific capacity of a battery using the hard carbon material made at 1500° C. of the present invention as the negative electrode material; and

FIG. 8 is a graph showing the relationship between specific capacity and current density of hard carbon materials doped with different nitrogen contents of the present invention.

### EMBODIMENTS

In a first embodiment, the invention discloses a hard carbon material for storing alkali metal ions. Specifically, the hard carbon material for storing alkali metal ions is a hard carbon material with a hydrogen content less than 2 wt. %, and has an ordered length range of 0-20 nm. Preferably, the hard carbon material for storing alkali metal ions is a hard carbon material with a hydrogen content being 0.3-1 wt. %, and has an ordered length range of 2-8 nm.

In one embodiment, the hard carbon material for storing alkali metal ions has a layer spacing more than 0.36 nm. Preferably, the layer spacing range is 0.37-0.4 nm.

In another embodiment, the hard carbon material with a hydrogen content less than 2 wt. % has an intensity ratio of the D band to G band (I_{D})/I_{G}) in Raman spectrum being 1.0-1.3. Preferably, the intensity ratio of the D band to G band (I_{D}/I_{G}) in Raman spectrum is 1.0-1.2. The intensity ratio of the D band to G band is used to quantify the structural crystalline characteristics of the hard carbon material for storing alkali metal ions of the present invention. By controlling the intensity ratio of the D band to G band within a specific range, the storing alkali metal ions capacity of the invented hard carbon material can be largely improved.

In still another embodiment, the hard carbon material with a hydrogen content less than 2 wt. % is used to store lithium ions, sodium ions, potassium ions or their combinations.

In still another embodiment, the hard carbon material with a hydrogen content less than 2 wt. % is part of negative electrodes of lithium ion batteries, sodium ion batteries or potassium ion batteries.

In a second embodiment, the invention provides a method for producing a hard carbon material for storing alkali metal ions, and comprises following steps.

(1) perform a pre-carbonization procedure to convert at least one precursor into a first intermediate product.

(2) perform a pulverization procedure to convert the first intermediate product into a second intermediate product.

(3) perform a doping procedure to mix the second intermediate product with at least one additive to form a third intermediate product and the weight percentage of the additive is 0.5-10 wt. % calculated based on the weight of the second intermediate product.

(4) perform a carbonization process to convert the third intermediate product into the hard carbon material for storing alkali metal ions.

In one embodiment, the pre-carbonization procedure is operated at 300-800° C. Preferably, the pre-carbonization procedure is operated at 500-700° C.

In one embodiment, the precursor comprises resin, anthracite, petroleum coke, cellulose or their combinations.

In one embodiment, doping procedure is to use the additive comprising oxygen-containing compounds, nitrogen-containing compounds, phosphorus-containing compounds, boron-containing compounds or their combinations. Preferably, the additive is hexamethyltetramine, air, boric acid or a combination thereof.

In another embodiment, the carbonization procedure is operated at 1100-1600° C. Preferably, the carbonization procedure is operated at 1150-1400° C.

In another embodiment, the hard carbon material for storing alkali metal ions has a hydrogen content less than 2 wt. % and an ordered length range of 0-20 nm. Preferably, the hard carbon material for storing alkali metal ions has a hydrogen content of 0.3-1 wt. % and an ordered length range of 2-8 nm.

In another embodiment, the hard carbon material for storing alkali metal ions has a layer spacing more than 0.36 nm. Preferably, the hard carbon material for storing alkali metal ions has a layer spacing range of 0.37-0.4 nm.

In still another embodiment, the hard carbon material with a hydrogen content less than 2 wt. % has an intensity ratio of the D band to G band (ID/IG) in Raman spectrum being 1.0-1.3. Preferably, the intensity ratio of the D band to G band (I_{D}/I_{G}) in Raman spectrum is 1.0-1.2. The intensity ratio of the D band to G band is used to quantify the structural crystalline characteristics of the hard carbon material for storing alkali metal ions of the present invention. By controlling the intensity ratio of the D band to G band within a specific range, the storing alkali metal ions capacity of the invented hard carbon material can be largely improved.

In still another embodiment, the hard carbon material for storing alkali metal ions is part of negative electrodes of lithium ion batteries, sodium ion batteries or potassium ion batteries.

The following experimental examples are used to further illustrate the technical features and effects of the present invention.

### Hydrogen Content Determination

The hard carbon material of the present invention uses hydrocarbon to measure repeatability (in compliance with GB/T476-2008). The hard carbon material sample is burned in the oxygen flow, and the generated water reacts with phosphorus pentoxide to generate metaphosphoric acid, which is electrolyzed to metaphosphoric acid. According to the electrolysis method, The hydrogen content is calculated based on the electricity consumed; the carbon dioxide generated is absorbed with a carbon dioxide absorbent, and the carbon content is calculated based on the increment of the absorbent. Trace amounts of sulfur oxides and chlorine in the hard carbon material samples were removed with silver permanganate pyrolysis products, and nitrogen oxides were removed with granular manganese dioxide to eliminate their interference on carbon determination.

### Layer Spacing and Ordered Length Measurements

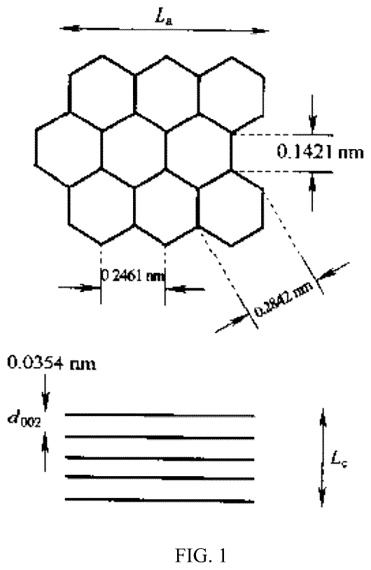

Please refer to FIG. 1, the C═C double bonds of the graphite crystal form a hexagonal structure, forming a plane (sheet surface). These surfaces stack up on each other to form a graphite crystal. The SP² hybridized large π bond in the plane and bonding energy is 345 KJ/mol. There is van der Waals force between layers, and the bonding energy is 16.7 KJ/mol. Microcrystalline parameters include layer spacing d₍₀₀₂₎ and the distance between the sheet surfaces. The ideal single crystal is 0.3354 nm, and the amorphous carbon is as high as 0.37 nm. La is the average size of graphite crystals along the a-axis direction, which is the order length. Lc is the thickness of the sheet surface stacked along the c-axis direction perpendicular to it, usually 1 nm˜10 μm.

The layer spacing d₍₀₀₂₎, the axial size of graphite crystallites (L c), the number of microcrystalline layers (n) and the radial size of graphite crystallites (order length La) are as follows, where λ is 1.54182 A (angstroms), β002 and β100 are the half maximum widths of peak (002) and peak (100).

$${d}_{002} = \frac{λ}{2 * sin {θ}_{002}}$$

$$Lc = \frac{0.89 λ}{{β}_{002} * cos {θ}_{002}}$$

$$n = \frac{Lc}{{d}_{002}} + 1$$

$$La = \frac{1.84 λ}{{β}_{100} * cos {θ}_{100}}$$

### Ion Battery Performance Evaluation

The steps for evaluating the performance of the hard carbon material of the present invention as the negative electrode material of the ion battery are as follows: the hard carbon material of the present invention, the conductive agent, and the adhesive are dissolved into the solvent NMP in a weight ratio of 92:3:5; counter electrode Sodium tablets/lithium tablets; the electrolyte is 1M sodium hexafluorophosphate (EC:PC:DEC=1:1:1) or 1M lithium hexafluorophosphate solvent (EC:EMC:DMC=1:1:1). After completing the test battery assembly, perform the performance test according to the following test procedures: let it stand for 2 hours; discharge: discharge at a constant rate of 0.1 C (1 C=300 mA/g) until the voltage is less than 0.001 V, discharge at a constant current of 50 uA until the voltage is less than 0.001 V, constant Discharge with 10 uA current until the voltage is less than 0.001 V; let it stand for 15 min; charge: charge at a constant rate of 0.1 C until the voltage is greater than 2 V.

### Experimental Example 1: Hard Carbon Materials Prepared at Different Carbonization Temperatures

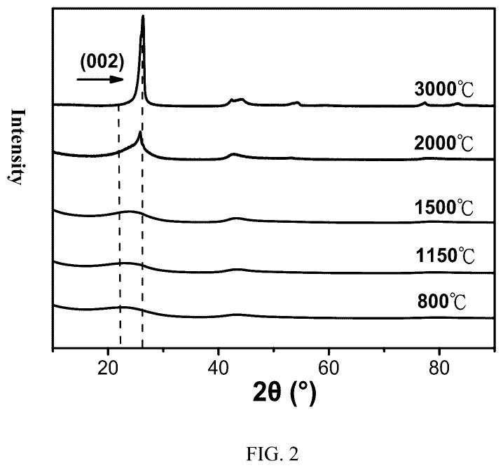

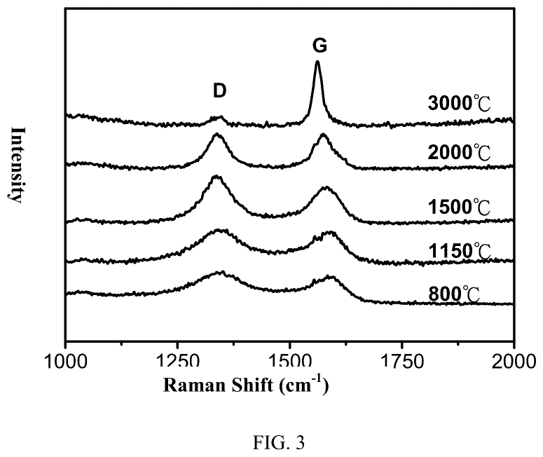

In this experimental example, resin is used as the precursor. After pre-carbonization at 600° C., the sample is pulverized and then carbonized at different temperatures to obtain hard carbon materials. The experimental results are shown in Table 1. The XRD pattern as shown in FIG. 2 was used to calculate the layer spacing and the Raman shift spectrum is shown in FIG. 3. When the carbonization temperature is at a low temperature of 800° C. and a high temperature of 2000° C., the intensity ratio of the D band and G band of the Raman spectrum of the hard carbon material is 1.251 and 0.924 respectively. As the negative electrode material of the sodium ion battery, its first Coulombic efficiency was measured. Both are lower than 50%; when the hard carbon material made at a carbonization temperature of 800° C. is used as the negative electrode material of the lithium-ion battery, its first Coulombic efficiency is measured, and the value is lower than 50%. This illustrates the structural characteristics of the hard carbon material of the present invention and the technical effects brought by the preparation method.

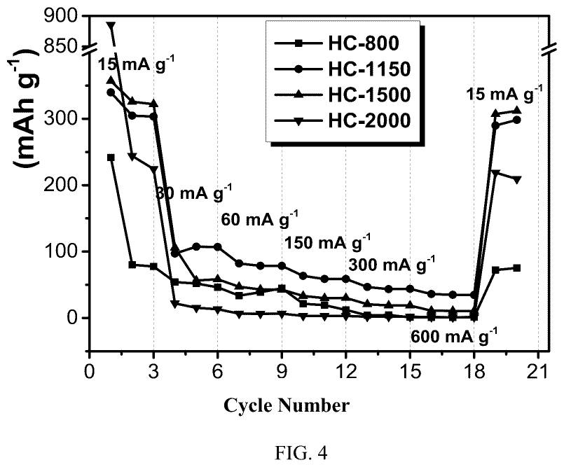

As shown in FIG. 4, the ion batteries using hard carbon materials HC1150 and HC1500 prepared at 1150 and 1500° C. as negative electrode materials still maintain the original specific capacity after 20 cycles of charge and discharge tests, but at 800 and 2000° C. The specific capacity of the ion battery using the prepared hard carbon materials HC 800 and HC 2000 as negative electrode materials dropped significantly after 20 cycles of charge and discharge tests, which confirmed the technical efficacy of this case.

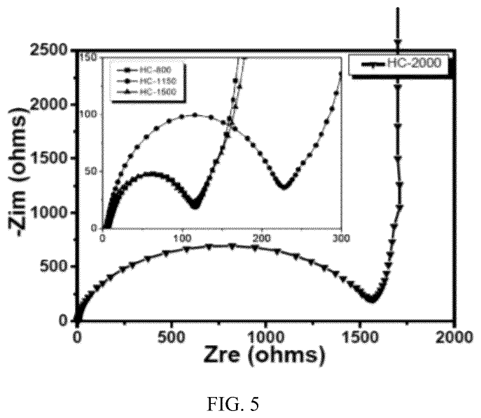

FIG. 5 is an ion battery impedance diagram using the hard carbon materials HC800, HC1150, HC1500 and HC2000 as negative electrode materials.

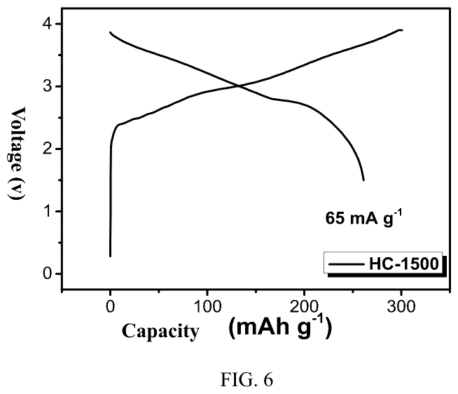

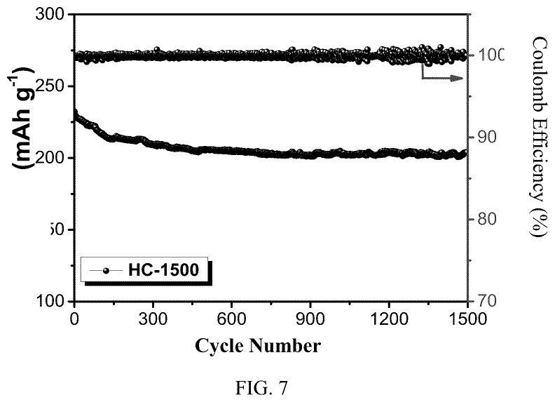

As shown in FIG. 6 and FIG. 7, ion battery using HC1500 which is prepared at 1500° C. as the negative electrode material. Apparently, the test ion battery still has a coulombic efficiency of 90% after 500 cycles. This confirms the technical efficacy of this case.

TABLE 1

| | | | | | sodium ion battery | | Lithium Ion Battery | |
|---|---|---|---|---|---|---|---|---|
| | H | | | | Gram | First | Gram | First |
| | content | d₍₀₀₂₎¹ | | | capacity | effect ⁴ | capacity | effect ⁴ |
| Exp No | % | (nm) | La² | I_{D}/I_{G}³ | (mAh g ⁻¹) | (%) | (mAh g ⁻¹) | (%) |
| Resin 800° C. | 1.193 | 0.3926 | 2.957 | 1.251 | 78.8 | 32.6 | 213.2 | 32.4 |
| Resin 1150° C. | 0.499 | 0.3882 | 3.021 | 1.198 | 303.8 | 89.4 | 237.6 | 69.0 |
| Resin 1500° C. | 0.303 | 0.3725 | 3.494 | 1.090 | 323.9 | 90.7 | 175.3 | 79.3 |
| Resin 2000° C. | 0.284 | 0.3444 | 5.889 | 0.924 | 147.8 | 16.8 | 125.5 | 83.7 |
| Resin 3000° C. | 0.025 | 0.3380 | 19.370 | 0.133 | — | — | 249.0 | 84.8 |

¹d₍₀₀₂₎ represents the layer spacing in nm.
²La represents the ordered length, the unit is nm.
³ID/IG represents the intensity ratio of the D band and G band in the Raman spectrum.
⁴ The first effect represents the first Coulomb efficiency.

### Experimental Example 2: Hard Carbon Materials Prepared from Different Precursors

In this experimental example, resin, anthracite, pitch coke, starch and cellulose were used. After the precursor is pre-carbonized at 600° C., the sample is crushed, and then subjected to high-temperature carbonization at 1150° C. to obtain hard carbon materials. The experimental results are shown in Table 2. This experimental example illustrates that the preparation method of the present invention is suitable for a variety of different precursors. The hydrogen content (H content) of the prepared hard carbon materials is less than 0.5%, and their order lengths are all between 2-8 nm, and has a good technical efficacy as battery negative electrode material.

TABLE 2

| | | | | | sodium ion battery | | Lithium Ion Battery | |
|---|---|---|---|---|---|---|---|---|
| | H | | | | Gram | First | Gram | first |
| | content | d₍₀₀₂₎ ¹ | | | capacity | effect ⁴ | capacity | effect |
| Exp No | % | (nm) | La ² | I_{D}/I_{G} ³ | (mAh g ⁻¹) | (%) | (mAh g ⁻¹) | (%) |
| Resin | 0.499 | 0.3882 | 3.021 | 1.198 | 303.8 | 89.4 | 237.6 | 69.0 |
| anthracite | 0.389 | 0.3500 | 4.897 | 1.051 | 143.6 | 64.5 | 253.0 | 62.3 |
| asphalt coke | 0.307 | 0.3508 | 5.029 | 0.998 | 150.2 | 53.0 | 265.2 | 66.5 |
| Resin + | 0.400 | 0.3720 | 4.175 | 1.103 | 250.6 | 78.5 | 255.2 | 68.2 |
| pitch coke | | | | | | | | |
| (1:1) | | | | | | | | |
| starch | 0.395 | 0.3724 | 3.551 | 1.177 | 268.8 | 80.7 | 288.6 | 75.6 |
| cellulose | 0.355 | 0.3892 | 3.102 | 1.188 | 246.1 | 81.9 | 305.1 | 73.7 |

¹ d₍₀₀₂₎ represents the layer spacing in nm.
² La represents the ordered length, the unit is nm.
³ ID/IG represents the intensity ratio of the D band and G band in the Raman spectrum.
⁴ The first effect represents the first Coulomb efficiency.

### Experimental Example 3: Hard Carbon Materials Prepared by Doping Different Additives

In this experimental example, the resin was pre-carbonized at 600° C. and then the sample was pulverized, and then doping treatment was performed, and finally high-temperature carbonization at 1150° C. was performed to obtain hard carbon materials. The experimental results are shown in Table 3. This experimental example illustrates that doping with different additives, such as hexamethyltetramine, air or boric acid, can better control the hydrogen content, layer spacing, ordering length and the Raman spectrum of the hard carbon material. The intensity ratio of the D band and the G band is in a narrower range, making the quality of the hard carbon material of the present invention more uniform. This shows that the doping step has an unexpected technical effect on the structural control of the hard carbon material. And when the hard carbon material is used as the negative electrode material of an ion battery, the gram capacity and first coulombic efficiency of the ion battery also maintain good battery performance.

TABLE 3

| | | | | | sodium ion battery | | Lithium Ion Battery | |
|---|---|---|---|---|---|---|---|---|
| | H | | | | Gram | First | Gram | First |
| | content | d₍₀₀₂₎ ¹ | | | capacity | effect ⁴ | capacity | effect ⁴ |
| Exp No | % | (nm) | La ² | I_{D}/I_{G} ³ | (mAh g ⁻¹) | (%) | (mAh g ⁻¹) | (%) |
| pure resin | 0.499 | 0.3882 | 3.021 | 1.198 | 303.8 | 89.4 | 237.6 | 69.0 |
| Resin + | 0.500 | 0.3871 | 3.358 | 1.153 | 302.6 | 88.3 | 279.3 | 62.6 |
| 5%(hexamethyltetramine) | | | | | | | | |
| Resin oxidized in air | 0.467 | 0.3905 | 2.997 | 1.212 | 308.2 | 86.4 | 248.3 | 60.5 |
| at +400° C. for 4 hours | | | | | | | | |
| Resin + 5% boric acid | 0.489 | 0.3903 | 3.015 | 1.208 | 298.3 | 86.5 | 253.2 | 68.8 |

¹ d₍₀₀₂₎ represents the layer spacing in nm.
² La represents the ordered length, the unit is nm.
³ ID/IG represents the intensity ratio of the D band and G band of the Raman spectrum.
⁴ The first effect represents the first Coulomb efficiency.

### Experimental Example 4: Hard Carbon Materials Made by Doping with Different Contents of Nitrogen (N)

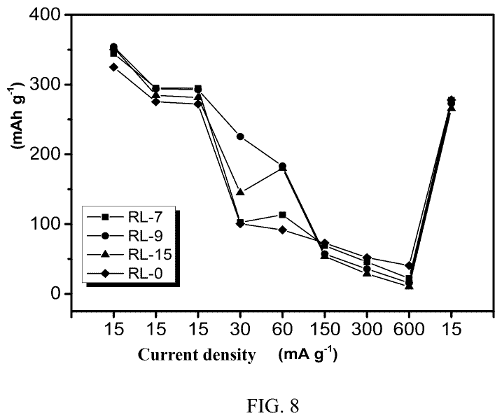

This experimental example uses different contents of nitrogen, namely 0%, 7%, 9% and 15%. The doping procedure was carried out, and then the hard carbon material was obtained by carbonization at a high temperature of 1150° C. The experimental results are shown in Table 4. This experimental example illustrates that doping different amounts of nitrogen-containing additives can effectively control the layer spacing greater than 0.36 nm and the intensity ratio of the D band and G band of the hard carbon material in the Raman spectrum. FIG. 8 shows the current density and specific capacity of hard carbon materials R0-1150, R7-1150, R9-1150 and R15-1150 made with different nitrogen contents doped at 1150° C.

TABLE 4

| | d₍₀₀₂₎ ¹ | | N₂ SSA2 | sodium ion battery |
|---|---|---|---|---|
| Exp No | (nm) | I_{D}/I_{G} ³ | (m ² g ⁻¹) | (mAh g ⁻¹) |
| Not added | 0.4077 | 1.175 | 4.31 | 3 26.2 |
| 7% nitrogen | 0.4021 | 1.081 | 1.80 | 3 43.9 |
| 9% nitrogen | 0.3929 | 1.064 | 3.02 | 3 53.0 |
| 15% nitrogen | 0.3986 | 1.165 | 3.13 | 3 53.5 |

¹ d₍₀₀₂₎ represents the layer spacing.
² Specific surface area, unit is m ² g ⁻¹.
³ ID/IG represents the intensity ratio of the D band and G band of the Raman spectrum.

The hard carbon materials produced in Experimental Example 1 and Experimental Example 4 above have properties as shown in Table 5 and electrical properties in Table 6.

TABLE 5

| | Conductivity | R s | R ct | D_{Na+} |
|---|---|---|---|---|
| Exp No | (S · cm ⁻¹) | (ohm) | (ohm) | (cm ² · s ⁻¹) |
| HC-800 | 3.769 | 7.052 | 110.7 | 8.64 × 10⁻¹¹ |
| HC-1150 | 21.985 | 3.872 | 209.9 | 8.54 × 10⁻¹² |
| HC-1500 | 27.645 | 4.438 | 102.5 | 2.63 × 10⁻¹⁰ |
| HC-2000 | 29.662 | 3.976 | 1555.0 | 2.65 × 10⁻¹² |

TABLE 6

| | Conductivity | R s | R ct | D_{Na+} |
|---|---|---|---|---|
| Exp No | (S · cm ⁻¹) | (ohm) | (ohm) | (cm2 · s ⁻¹) |
| R0-1150 | 3.544 × 10 ⁻⁵ | 6.109 | 4 55.4 | 2.803 × 10 ^{-1 0} |
| R7-1150 | 22.772 | 5.681 | 1 46.5 | 6.306 × 10 ⁻⁸ |
| R9-1150 | 24.714 | 5.194 | 1 92.4 | 4.092 × 10⁻⁸ |
| R15-1150 | 21.507 | 6.071 | 2 81.5 | 5.652 × 10⁻⁸ |

In summary, the present invention discloses a hard carbon material for storing alkali metal ions. Specifically, the hydrogen content of the hard carbon material for storing alkali metal ions is less than 2 wt. % and its order length (La) range is 0-20 nm and its layer spacing is greater than 0.36 nm. Furthermore, the hard carbon material for storing alkali metal ions of the present invention uses low-temperature processes and doping additives to control the upper limit of the hydrogen content of the hard carbon material and prevent the layer spacing from narrowing, thereby improving the material quality and raising technical efficacy of alkali metal ions storage capacity. Accordingly, the hard carbon material for storing alkali metal ions of the present invention has higher alkali metal ions storage capacity and can be widely used as negative electrode material for lithium-ion batteries, sodium-ion batteries or potassium-ion batteries. Secondly, the present invention provides a method for preparing hard carbon materials for storing alkali metal ions. Specifically, the preparation method uses steps such as low-temperature pre-carbonization, pulverization, doping and carbonization to produce a hydrogen content of less than 2 wt. %. and a hard carbon material with a high ability to store alkali metal ions whose order length (La) ranges from 0 to 20 nm and whose layer spacing is greater than 0.36 nm. The preparation method of the present invention uses a low-temperature sintering process, and the operating temperature in the entire process is less than 1800° C. By this technical means, the technical effect of controlling the upper limit of hydrogen content and the lower limit of layer spacing is achieved, and at the same time, additives are added before carbonization to prevent the layer spacing is significantly narrowed at the operating temperature of carbonization, thereby creating a synergistic effect.

Obviously, many modifications and variations are possible in the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A hard carbon material for storing alkali metal ions, being a hard carbon material with a hydrogen content less than 2 wt. %, and having an ordered length range of 0-20 nm and a layer spacing more than 0.36 nm.

2. The hard carbon material for storing alkali metal ions of claim 1, wherein the hard carbon material with a hydrogen content less than 2 wt. % has an intensity ratio of the D band to G band (I_{D}/I_{G}) in Raman spectrum being 1.0-1.3.

3. The hard carbon material for storing alkali metal ions of claim 1, wherein the hard carbon material with a hydrogen content less than 2 wt. % is used to store lithium ions, sodium ions, potassium ions or their combinations.

4. The hard carbon material for storing alkali metal ions of claim 1, wherein the hard carbon material with a hydrogen content less than 2 wt. % is a part of negative electrode of lithium ion batteries, sodium ion batteries or potassium ion batteries.

5. A method for producing a hard carbon material for storing alkali metal ions, comprising, (1) performing a pre-carbonization procedure to convert at least one precursor into a first intermediate product; (2) performing a pulverization procedure to convert the first intermediate product into a second intermediate product; (3) performing a doping procedure to mix the second intermediate product with at least one additive to form a third intermediate product and the weight percentage of the additive is 0.5-10 wt. % calculated based on the weight of the second intermediate product; and (4) performing a carbonization process to convert the third intermediate product into the hard carbon material for storing alkali metal ions.

6. The method for producing a hard carbon material for storing alkali metal ions of claim 5, wherein the pre-carbonization procedure is operated at 300-800° C.

7. The method for producing a hard carbon material for storing alkali metal ions of claim 5, wherein the precursor comprises resin, anthracite, petroleum coke, cellulose or their combinations.

8. The method for producing a hard carbon material for storing alkali metal ions of claim 5, wherein the additive comprises oxygen-containing compounds, nitrogen-containing compounds, phosphorus-containing compounds, boron-containing compounds or their combinations.

9. The method for producing a hard carbon material for storing alkali metal ions of claim 5, wherein the carbonization procedure is operated at 1100-1600° C.

10. The method for producing a hard carbon material for storing alkali metal ions of claim 5, wherein the hard carbon material for storing alkali metal ions has a hydrogen content less than 2 wt. %.

11. The method for producing a hard carbon material for storing alkali metal ions of claim 5, wherein the hard carbon material for storing alkali metal ions has an ordered length range of 0-20 nm and a layer spacing more than 0.36 nm.

12. The method for producing a hard carbon material for storing alkali metal ions of claim 5, wherein the hard carbon material for storing alkali metal ions has an intensity ratio of the D band to G band (I_{D}/I_{G}) in Raman spectrum being 1.0-1.3.

13. The method for producing a hard carbon material for storing alkali metal ions of claim 5, wherein the hard carbon material for storing alkali metal ions is part of negative electrodes of lithium ion batteries, sodium ion batteries or potassium ion batteries.
